(19) United States
(12) Patent Application Publication
(10) Pub. No.: US 2022/0356354 A1
(43) Pub. Date: Nov. 10, 2022

(54) HIGH FREQUENCY SILICONE DAMPENING GEL

(71) Applicant: Dow Silicones Corporation, Midland, MI (US)

(72) Inventors: Gyuyoung Lee, Jincheon-gun (KR); Min Hee Kwon, Jincheon-gun (KR); Yungjin Park, Jincheon-gun (KR)

(21) Appl. No.: 17/778,100

(22) PCT Filed: Jan. 7, 2021
(86) PCT No.: PCT/US2021/012469

§ 371 Date: May 19, 2022

Related U.S. Application Data
(60) Provisional application No. 62/969,705, filed on Feb. 4, 2020.

(51) Int. Cl. C08L 83/08; C08G 77/28

(52) U.S. Cl. CPC C08L 83/08; C08G 77/28

(57) ABSTRACT

A composition contains 45-65 weight-percent (wt %) of a linear polyorganosiloxane with terminal vinyl functionality, 39 wt % to less than 50 wt % alkenyl-free polyorganosiloxane resin comprising R₃SiO_{1/2} and SiO_{4/2} siloxane units at an average molar ratio of greater than zero to 10; where R is independently in each occurrence selected from a group consisting of alkyl groups containing from one to 10 carbon atoms; 0.5-15 wt % mercapto-functional linear polyorganosiloxane crosslinker; 0.01-0.1 wt % radical stabilizer; 0.01-3 wt % thiol-ene photopolymerization initiator; 0-10 wt % fumed silica; and 0-5 wt % polydimethylsiloxane; wherein weight-percent values are relative to composition weight, the composition has a molar ratio of SiH/vinyl functional groups that is greater than 0.3 and at the same time less than 0.8 and wherein the composition is free of alkenyl functional polyorganosiloxane resin, free of alkoxysilyl containing components, and free of polysiloxane comprising R^{SH}SiO_{3/2} siloxane units, where R^{SH} is a mercapto-group containing hydrocarbyl.

### FIELD OF THE INVENTION

The present invention relates to a polysiloxane composition that can cure to form a gel that can act as a high frequency dampening gel.

### INTRODUCTION

Cameras on mobile phones currently tend to utilize voice coil motor (VCM) devices to focus the lens. Cameras with VCM devices typically also have a VCM driver to operate the VCM. The VCM/VCM driver combination is desirable to minimize sound generated by the lens when changing focus. The VCM contains springs that extend when the lens is extended, but movement of the spring also produces mechanical ringing, which can be problematic when at a resonance frequency with the camera module. Camera modules typically have a resonance frequency in a range of 50 Hertz (Hz) to 150 Hz. To dampen ringing from the lens, the VCM driver is designed to generate an optimized current ramp to minimize resonance frequency generation.

Dampening gels are desirable alternatives to using a VCM driver and can conceivably reduce the size of the camera unit by replacing the VCM driver. However, a challenge with dampening gels is identifying one that has the necessary characteristics, which include: (i) having a Tan Delta value at 70 Hz that is in a range of 1.0 to 5.0; and (ii) does not tear when measuring Tan Delta over a frequency range of one to 70 Hz so as to have longevity in the application.

Dampening vibrations with gels is generally known, but for lower frequency dampening. Dampening the higher frequency (70 Hz range) associated with VCM devices is new and both in finding a gel that has both dampening ability and durability (resistance to cracking or tearing) in this higher frequency range.

### BRIEF SUMMARY OF THE INVENTION

The present invention provides a composition that cures to form a dampening gel that: (i) has a Tan Delta value at 70 Hz that is in a range of 1.0 to 5.0; and (ii) does not tear when measuring Tan Delta over a frequency range of one to 70 Hz.

A dampening gel having these properties was surprisingly discovered to be a thiol-ene cured silicone gel prepared by from a specific reaction composition comprising 39 to less than 50 weight-percent alkenyl-free silicone resin (for Tan Delta at 70 Hz) and use of a silicon atom-to-vinyl ratio that is greater than 0.3 (to preclude tearing).

Surprisingly and unexpectedly, the cured composition of the present invention can be used in articles such as camera phones with VCM devices to dampen high frequency (70 Hz) vibrations.

In a first aspect, the present invention is a composition comprising: (a) 45-65 weight-percent of a linear polyorganosiloxane with terminal vinyl functionality; (b) 39 weight-percent to less than 50 weight-percent alkenyl-free polyorganosiloxane resin comprising R₃SiO_{1/2} and SiO_{4/2} siloxane units at an average molar ratio of greater than zero and at the same time 10 or less; where R is independently in each occurrence selected from a group consisting of alkyl groups containing from one to 10 carbon atoms; (c) 0.5-15 weight-percent mercapto-functional linear polyorganosiloxane crosslinker; (d) 0.01-0.1 weight-percent radical stabilizer; (e) 0.01-3weight-percent thiol-ene photopolymerization initiator; (f) 0-10 weight-percent fumed silica; and (g) 0-5 weight-percent polydimethylsiloxane; wherein weight-percent values are relative to composition weight, the composition has a molar ratio of SiH/vinyl functional groups that is greater than 0.3 and at the same time less than 0.8 and wherein the composition is free of alkenyl functional polyorganosiloxane resin, free of alkoxysilyl containing components, and free of polysiloxane comprising R^{sH}SiO_{3/2} siloxane units, where R^{SH} is a mercapto-group containing hydrocarbyl.

In a second aspect, the present invention is a process comprising: (a) applying the composition of the first aspect to a substrate; and (b) exposing the composition to light to initiate curing by a thiol-ene reaction.

In a third aspect, the present invention is an article comprising an uncured or cured form of the composition of the first aspect on a substrate.

The composition of the present invention is useful for curing into a dampening gel that is has a Tan Delta value at 70 Hz that is in a range of 1.0 to 5.0 and also does not tear when measuring Tan Delta over a frequency range of one to 70 Hz.

### DETAILED DESCRIPTION OF THE INVENTION

Test methods refer to the most recent test method as of the priority date of this document when a date is not indicated with the test method number. References to test methods contain both a reference to the testing society and the test method number. The following test method abbreviations and identifiers apply herein: ASTM refers to ASTM

International; EN refers to European Norm; DIN refers to Deutsches Institut für Normung; and ISO refers to International Organization for Standards.

“Multiple” means two or more. “And/or” means “and, or as an alternative”. All ranges include endpoints unless otherwise indicated. Products identified by their tradename refer to the compositions available from the suppliers under those tradenames at the priority date of this document unless otherwise stated herein.

“Polysiloxane” refers to a polymer containing multiple siloxane bonds. Polysiloxanes comprise siloxane units that are selected from those known in the art as: SiO₄₁₂ (“Q” type), RSiO_{3/2} (“T” type), R₂SiO_{2/2} (“D” type), and R₃SiO_{1/2} (“M” type). The subscript on the R group indicates how many R groups are bound to the silicon atom. The subscript on the oxygen indicates how many oxygens are bound to the silicon that are also bound to another silicon (that is, how siloxane linkages, “Si—O—Si” bonds, the silicon atom participates in) divided by 2 because the oxygen is shared with another silicon atom so only half of each oxygen is considered bound to each silicon atom. Hence, a D-type unit comprises a silicon atom bound to two R groups and sharing two oxygens with other silicon atoms, so it includes two half oxygen atoms. In general, the R group can be any substituent other than—OSi (that is, a siloxane bond to the silicon). Generally, the R group is a hydrogen or hydrocarbyl bound to the silicon atom through a carbon-silicon bond. However, the R group in the broadest scope herein can also be a group bound to the silicon atom with an atom other than hydrogen or carbon, for instance sulfur or oxygen. For instance, the R group can be selected from hydroxyl or alkoxyl groups, which are jointly referred to as “OZ” groups. Determine the composition of polysiloxanes using ²⁹Si nuclear magnetic resonance spectroscopy (²⁹Si NMR). Conduct ²⁹Si NMR of samples using a Varian XL-400 spectrometer. Supplement information from the ²⁹Si NMR with ¹³C NMR and ¹H NMR to characterize R groups.

“Polysiloxane resin” refers to a polysiloxane where the sum of T type and Q type siloxane units account for 10 mol % or more of the total moles of siloxane units in the polysiloxane. A polyorganosiloxane resin can comprise 20 mol % or more, 30 mol % or more, 40 mol % or more, 50 mol % or more, 60 mol % or more, 70 mol % or more, 80 mole % or more and even 90 mol % or more of a combination of T type and Q type siloxane units relative to total moles of siloxane units in the polysiloxane.

“Liner polysiloxane” refers to a polysiloxane that comprises D type siloxane units terminated with M type siloxane units and comprising 3 mol % or less, preferably 2 mol % or less, more preferably one mol % or less and can contain zero mol % of a sum of T type and Q type siloxane units relative to total siloxane units in the polysiloxane.

“Polyorganosiloxane” refers to a polysiloxane with a T, D and/or M type siloxane unit comprising an R group that is an organic group.

“Hydrocarbyl” is a univalent radical derived from a substituted or non-substituted hydrocarbon. Substituted hydrocarbons have one or more than one hydrogen or carbon atom replaced with another atom or substituent. Herein, hydrocarbyl in each occurrence can be either substituted or non-substituted, corresponding respectively to hydrocarbyls derived from either a substituted or non-substituted hydrocarbon.

The composition of the present invention comprises a linear polyorganosiloxane with terminal vinyl functionality. Desirably, the linear polyorganosiloxane consists of two vinyl functional M type siloxane units on either end of a series of D type siloxane units. The linear polyorganosiloxane can have the composition of Formula (I):

[ViR₂SiO_{1/2}][R₂SiO_{2/2}]_{d}[ViR₂SiO_{1/2}] (I)

where Vi refers to a vinyl group, R is independently in each occurrence selected from hydrocarbyl groups having from one to 10 carbons, preferably R is in each occurrence selected from a group consisting of alkyl and alkenyl group having from one to 10 carbons, more preferably R is in each occurrence selected from a group consisting of methyl, ethyl, propyl, butyl, hexyl and heptyl groups. Subscript d refers to the average number of [R₂SiO_{2/2}]siloxane units in the polyorganosiloxane per molecule and is typically 10 or more, 20 or more 30 or more 40 or more, 50 or more, and can be 100 or more, 110 or more 120 or more, 130 or more 140 or more 150 or more, 200 or more, 250 or more, 275 or more, 280 or more, even 290 or more while at the same time is typically 500 or less, 450 or less, 400 or less, 350 or less, 325 or less, 300 or less, even 290 or less. The linear polyorganosiloxane with terminal vinyl functionality can be selected from those of Formula 1 where R in each occurrence is methyl and d is in a range of 40 to 290.

The linear polyorganosiloxane with terminal vinyl functionality is typically present in the composition at a concentration of 45 weight-percent (wt %) or more, 50 wt % or more, 55 wt % or more and can be 60 wt % or more while at the same time is generally 65 wt % or less, 60 wt % or less and can be 55 wt % or less, even 50 wt % or less relative to composition weight.

The composition of the present invention comprises an alkenyl-free polyorganosiloxane resin. The alkenyl-free polyorganosiloxane resin comprises M type (R₃SiO_{1/2}) and Q type (SiO_{4/2}) siloxane units where R is independently in each occurrence selected from a group consisting of alkyl groups containing from one to 10 carbon atoms, preferably each R group is a methyl. The average molar ratio of M type to Q type siloxane units is greater than zero and is preferably 0.8 or more, 0.9 or more and most preferably one or more while at the same time is desirably 1.2 or less, preferably 1.1 or less and most preferably 1.0 or less. The alkenyl-free polyorganosiloxane resin can comprise T type units, particularly T^{OH} units ((HO)SiO_{3/2}) in amounts of 15 mol % or less, preferably 12 mol % or less, 10 mol % or less, 8 mol % or less, 6 mol % or less, 4 mol % or less, 2 mol % or less relative to total moles of siloxane units. Desirably, the alkenyl-free polyorganosiloxane resin consists of M type, Q type and optionally T type siloxane units. The alkenyl-free polyorganosiloxane resin is free of alkenyl functionality.

The alkenyl-free polyorganosiloxane resin desirably has a number average molecular weight of 19,500 Daltons (Da) or more, and can be 20,000 Da or more, 21,000 Da or more 22,000 Da or more and even 23,000 Da or more while at the same time is typically 24,000 Da or less, 23,500 Da or less, 23,000 Da or less. Determine number average molecular weight for the alkenyl-free polyorganosiloxane resin by gel permeation chromatography (GPC) using a Waters 2695 separations module with seal wash, degasser and Waters 2414 refractive index detector. Use three (7.8 by 300 millimeter) Styragel HR columns (molecular weight separation range of 100 to 4,000,000) and Styragel guard column (4.6 by 30 millimeter) with toluene as the columns. Prepare samples as s 0.5 wt % solution in HPLC grad tetrahydrofuran and filter through 0.45 micrometer polytetrafluoroethylene syringe filters. Use a flow rate of one milliliter per minute, detector and column temperature of 45 degrees Celsius, an injection volume of 100 microliters and a run time of 60 minutes.

Alkenyl-free polyorganosiloxane resin is present at a concentration of 39 wt % or more, 40.3 wt % or more, even 45 wt % or more and at the same time is 50 wt % or less, 45 wt % or less, or 40.3 wt % or less relative to composition weight.

The composition of the present invention comprises a mercapto-functional linear polyorganosiloxane crosslinker (“crosslinker”). The crosslinker is a different material different from the linear polyorganosiloxane with terminal vinyl functionality. The crosslinker is a polysiloxane comprising, or consisting of, M and D type siloxane units with at least one R group on the M and/or D siloxane unit being a hydrocarbyl group, preferably an alkyl group, that contains a mercapto functionality (which is also known as a thiol functionality: —SH), preferably at the end of the alkyl chain opposite where the alkyl group bonds to the silicon atom of the siloxane unit (that is, a “terminal thiol group”). Desirably, the crosslinker comprises or consists of M and D type siloxane units with the R group on the M units being alkyl groups and some of the R groups on some or all the D units being mercapto functional alkyl groups, preferably with each having terminal thiol group, with the remaining R groups on the D units being alkyl groups. The crosslinking can comprise or consist of the following the following siloxane units: (R₃SiO_{1/2}), (R₂SiO_{2/2}), and (RR′SiO_{2/2}) where R in each occurrence is selected from hydrocarbyls, preferably alkyls (most preferably methyl groups) and R′ is an alkyl with a terminal thiol group. The crosslinker is free of T type siloxane units that contain a mercapto-group containing hydrocarbyl (an R^{sH}SiO_{3/2} siloxane unit, where R^{SH} is a mercapto-group containing hydrocarbyl). Examples of suitable mercapto functional hydrocarbyl groups include any one or combination of more than one selected from:
—CH₂SH, —CH₂CH₂SH; —CH₂CH₂CH₂SH, and —CH₂CH₂CH₂CH₂SH.

Examples of suitable crosslinkers include any one or any combination of more than one selected from those having the following formula:

(R₃SiO_{1/2})(R₂SiO_{2/2})_{d}″(RR′SiO_{2/2})_{d}′(R₃SiO_{1/2}) (II)

where each R and R′ is as previously defined for the crosslinker and subscripts d′ and d″ indicate the average number of the associated siloxane unit per molecule. Subscript d′ typically has a value of one or more, 2 or more, 3 or more, 4 or more, 5 or more, even 10 or more while at the same time typically having a value of 100 or less, 75 or less, 50 or less, and can be 45 or less 40 or less, 35 or less, 30 or less, 25 or less, 20 or less, 15 or less, 10 or less, even 8 or less, 6 or less, or 5 or less. Subscript d″ typically as a value of zero or more, one or more, 2 or more, 3 or more, 4 or more, 5 or more, even 10 or more while at the same time typically having a value of 100 or less, 75 or less, 50 or less, and can be 45 or less 40 or less, 35 or less, 30 or less, 25 or less, 20 or less, 15 or less, 10 or less, even 8 or less, 6 or less, or 5 or less. Desirably, the R groups are alkyl groups, most preferably methyl groups.

The crosslinker is typically present at a concentration of 0.5 wt % or more, one wt % or more, 2 wt % or more, 3 wt % or more, even 5 wt % or more while at the same time is typically 15 wt % or less, 10 wt % or less, 5 wt % or less, 4 wt % or less, 3 wt % or less or even 2 wt % or less relative to composition weight. At the same time, the relative concentration of crosslinker to linear polyorganosiloxane with terminal vinyl functionality is such that the molar ratio of SiH-to-vinyl functional groups (SiH/vinyl functional groups) is more than 0.3, preferably 0.4 or more, 0.5 or more and even 0.6 or more while at the same time is less than 0.8, and can be 0.7 or less, 0.6 or less, 0.5 or less, even 0.4 or less. When the molar ratio of SiH-to-vinyl functional groups is 0.3 or less the resulting cured composition does not have sufficient crosslinking to resist tearing when exposed to vibrational frequencies in the 70 Hz range. When the molar ratio of SiH-to-vinyl functional groups is 0.8 or higher the tan Delta in the 70 Hz range is outside the desired range of 1-5.

The composition of the present invention further comprises a radical stabilizer (“antioxidant”, “inhibitor” or “scavenger”). Examples of suitable stabilizers include any one or any combination of more than one component selected from a group consisting of monophenols such as butylated hydroxytoluene (“BHT”), 2,6-di-t-butyl-p-cresol, 2-t-butyl-4-methoxyphenol, 2,6-t-butyl-4-ethylphenol; bisphenols such as 2,2′-methylene-bis(4-methyl-6-t-butylphenol); and polymeric phenols such as 1,1,3-tris(t-methyl-4-hydroxy-5-t-butylphenyl)(butane, 1,3,5,-trimethyl-2,4,6-tris(3,5-di-t-butyl-4-hydroxybenzyl)benzeine, tetrakis[methylene-3-(3′,5′-di-t-butyl-4′-hydroxyphenyl)propionate]methane, bis[3,3′-bis(4′-hydroxy-3-t-butylphenyl)butyric acid glycol ester, and tocopherol.

Radical stabilizer is typically present at a concentration of 0.01 wt % or more, 0.03 wt % or more, 0.05 wt % or more, even 0.08 wt % or more while at the same time typically 0.10 wt % or less, 0.8 wt % or less, 0.05 wt % or less, or even 0.03 wt % or less relative to composition weight.

The composition of the present invention further comprises a thiol-ene photopolymerization initiator (“initiator”). The initiator generates free radicals when exposed to light. Desirably, the initiator is a visible light initiator, a UV light initiator, or a combination thereof. Most preferably, the initiator is a UV light photoinitiator. Examples of suitable visible light initiators include any one or any combination of more than one compound selected from a group consisting of camphoquinone peroxyester initiators, non-fluorene carboxylic acid peroxyester initiators and alkyl thioxanthones such an isopropyl thioxanthone. Examples of suitable UV initiators include any one or any combination of more than one compound selected from a group consisting of benzophenone, substituted benzophenones, acetophenone, substituted acetophenone, benzoin and its alkyl esters, xanthone, and substituted xanthone. Particularly desirable UV initiators include diethoxyacetophenone (DEAP), benzoin methyl ether, benzoin ethyl ether, benzoin isopropyl ether, diethoxyxanthone, chloro-thioxanthone, azo-bisisobutyronitrile, N-methyldiethanolaminebenzophenone, 2-hydroxy-2-methylpropiophenone, and any combinations thereof.

Initiator is typically present at a concentration of 0.01 wt % or more, 0.05 wt % or more, 0.10 wt % or more, 0.5 wt % or more, one wt % or more, even 2 wt % or more while at the same time is typically present at a concentration of 3 wt % or less, 2 wt % or less, even one wt % or less relative to composition weight.

The composition of the present invention can further comprise fumed silica at a concentration of 10 wt % or less, 8 wt % or less, 6 wt % or less, 4 wt % or less, 2 wt % or less, even one wt % or less relative to composition weight. The composition can be free of fumed silica.

The composition of the present invention can further comprise polydimethyl siloxane (PDMS). PDMS can be desirable as a viscosity modifier, particularly to reduce the viscosity of the composition. Typically, PDMS is present in the composition at a concentration of 5 wt % or less, 4 wt % or less, 3 wt % or less 2 wt % or less, even one wt % or less relative to composition weight. The composition can be free of PDMS.

The composition of the present invention does not require and is can be free of any one or any combination of more than one of the following: alkoxysilyl containing components, alkenyl functional polyorganosiloxane resin and polysiloxane comprising R^{sH}SiO_{3/2} siloxane units, where R^{SH} is a mercapto-group containing hydrocarbyl.

Additionally, the composition can be free of any one or any combination of more than one of the following: cyclic hindered amines, hollow glass fillers, hollow fillers other than glass hollow glass fillers, (RSiO_{3/2}) siloxane units where R comprises alkenyl functionality, and alkoxy functional polysiloxanes.

The composition of the present invention is useful for curing into a gel that has dampening properties. Generally, to cure the composition of the present invention apply it to a substrate and expose the composition to light to initiate curing by thiol-ene reaction. Typically, the method occurs in that order, first applying to a substrate and then exposing to light to cure. The light used to cure is usually ultraviolet light. The substrate can be any substrate, but the composition of the present invention is particularly useful for curing into a high frequency dampening material for use in camera assembly so the substrate is desirably a component of a lens assembly or other part of a camera assembly. For example, the composition of the present invention can be applied to one or more than one spring of a lens assembly and cured to form a dampening material in contact with the spring(s) by exposing the composition on the spring(s) to light. In that regard, the present invention further comprises an article comprising an uncured or cured form of the composition of the present invention on a substrate, especially when the substrate is a component of a lens assembly or camera.

### EXAMPLES

Table 1 lists the components for the samples, the compositions of which are in Tables 2 and 3, with values for each component listed in wt % relative to composition weight. Tables 2 and 3 also present characteristics of the sample composition and characterization of the sample compositions after curing.

Sample Preparation

Prepare samples in a three step process. First, prepare a Resin/Polymer Masterbatch by combining the linear polyorganosiloxane with terminal vinyl functionality and the alkenyl-free polyorganosiloxane resin together in a glass flask. Stir and shake the flask to mix well. Roto-vap off any organic solvents. Second prepare a Stabilizer/Initiator Masterbatch by combining the stabilizer and thiol-ene photopolymerization initiator together in a small cup or container. Mix until components are homogeneous and keep away from ultraviolet light exposure. Third, combine the Resin/Polymer Masterbatch, Stabilizer Initiator Masterbatch, Crosslinker, Silica (when used) and PDMS (when used) in a cup or container. Mix until components are homogeneous and keep away from ultraviolet light exposure.

Sample Curing

Place 5-10 grams of sample into a 30 milliliter polyethylene cup. Centrifuge the sample in the cup to level it. Expose the sample to 395 nanometer light for 0.5 to one minute with a light intensity exposure of one Watt per square centimeter.

Sample Characterization

Penetration Value and Penetration Depth.

After curing measure the Penetration value using a RIGO RPM-201 Penetrometer using one-quarter scale plunger (8.241 grams). The penetration test begins with leveling the material in a cup at 25° C., plus or minus one ° C. The one-quarter scale plunger is dropped into the cup onto the sample for 10 seconds, creating a hole in the sample. The instrument records the penetration value and depth of this hole. The method is based on ASTM D-1403.

Tan Delta.

Dispense several grams of sample material between Parallel Plate 25 and stationary plat fixtures in a circle with approximately 25 millimeter diameter and approximately one millimeter thickness. Enclose the sample in an ultraviolet light chamber for full curing. When the storage modulate of the sample reaches the saturation level, apply the frequency sweep to measure the tan delta value from one Hz to 100 Hz. Maintain the temperature at 25° C., amplitude/strain is fixed at 3 percent, frequency range is applied form one Hz to 100 Hz. The analyzer applies torsional oscillation to the cured sample while slowly moving with the given amplitude and frequency settings. Use an MCR 502 model device from Anton Paar. The test method is based on ASTM D4473 and ASTM D330.

TABLE 1

| Component | Description | Source |
|---|---|---|
| Linear | Dimethyl, methylvinyl siloxane, | Obtainable from The Dow |
| polyorganosiloxane | dimethylvinylsiloxy-terminated having | Chemical Company under the |
| with terminal vinyl | the following average formula: | name XIAMETER ™ RBL-9117. |
| functionality (“LV”) 1 | [Vi(CH₃)₂SiO_{1/2}]₂[(CH₃)₂SiO_{2/2}]₂₉₀ | |
| LV2 | Dimethyl, methylvinyl siloxane, | Obtainable from The Dow |
| | dimethylvinylsiloxy-terminated having | Chemical Company under the |
| | the following average formula: | name XIAMETER ™ RBL-9119. |
| | [Vi(CH₃)₂SiO_{1/2}]₂[(CH₃)₂SiO_{2/2}]₁₃₉ | |
| LV3 | Dimethyl, methylvinyl siloxane, | Obtainable from The Dow |
| | dimethylvinylsiloxy-terminated having | Chemical Company under the |
| | the following average formula: | name DOWSIL ™ LVP-60. Also |
| | [Vi(CH₃)₂SiO_{1/2}]₂[(CH₃)₂SiO_{2/2}]₄₁ | as SiSiB ™ VF6030 Fluid from |
| | | SiSiB Silicones. |
| Alkenyl-free | An endcapped polysiloxane MQ resin | Obtainable from The Dow |
| polyorganosiloxane | having the following average formula: | Chemical Company under the |
| resin (AFPR) 1 | [(CH₃)₃SiO_{1/2}]₅₀[SiO_{4/2}]₅₀ | name DOWSIL ™ 7426 PSA |
| | | Additive. |
| AFPR2 | Dimethylvinylated and trimethylated | Obtainable from The Dow |
| | silica having the following average | Chemical Company under the |
| | formula: | name DOWSIL ™ 6-3444 Int. |
| | [Vi(CH₃)₂SiO_{1/2}]₄[(CH₃)₃SiO_{1/2}]₄₀[SiO_{4/2}]₅₆ | |
| Crosslinker | Mercapto propyl crosslinker having the | Obtainable from The Dow |
| | following average formula: | Chemical Company under the |
| | [(CH₃)₃SiO_{1/2}]₂[(CH₃)₂SiO_{2/2}]_{45.8}[PrSH(CH₃)SiO_{2/2}]_{4.3} | name DOWSIL ™ Q3-6654. |
| | where “PrSH” is —CH₂CH₂CH₂SH. | |
| Stabilizer | Butylated hydroxytoluene (“BHT”) | Available from Chemi Max in |
| | | Korea as well as Sigma-Aldrich. |
| Thiol-ene | 2-hydroxy-2methylpropiophenone | Available from BASF under the |
| photopolymerization | | name DAROCUR-1173. |
| initiator (“Initiator”) | | |
| Fumed Silica | Fumed silica powder having an | Available AEROSIL ™ 200 from |
| | average surface area of 200 square | Nippon Aerosil Company. |
| | meters per gram and average particle | AEROSIL is a trademark of |
| | size of 12 nanometers | Evonik Degussa GmbH. |
| PDMS | Polydimethyl siloxane having an | Available as 200 Fluid, 20 cst |
| | average viscosity of 20 | from The Dow Chemical |
| | milliPascals*seconds | Company. |

TABLE 2

| Sample | 1 | 2 | 3 | 4 | 5 | 6 | 7 | 8 |
|---|---|---|---|---|---|---|---|---|
| LV1 (wt %) | 56.11 | 55.77 | 54.93 | 0 | 0 | 0 | 52.89 | 0 |
| LV2 (wt %) | 0 | 0 | 0 | 54.89 | 55.23 | 55.58 | 0 | 26.86 |
| LV3 (wt %) | 0 | 0 | 0 | 0 | 0 | 0 | 0 | 26.86 |
| AFPR 1 (wt %) | 40.30 | 39.88 | 39.48 | 39.42 | 39.66 | 39.91 | 39.73 | 38.56 |
| Crosslinker (wt %) | 1.56 | 1.52 | 1.56 | 3.66 | 3.08 | 2.48 | 1.56 | 5.70 |
| Stabilizer (wt %) | 0.03 | 0.03 | 0.03 | 0.03 | 0.06 | 0.03 | 0.03 | 0.03 |
| Initiator | 2.00 | 2.00 | 2.00 | 2.00 | 2.00 | 2.00 | 2.00 | 2.00 |
| Fumed Silica | 0 | 1 | 2 | 0 | 0 | 0 | 0 | 0 |
| PDMS | 0 | 0 | 0 | 0 | 0 | 0 | 3.8 | 0 |
| SiH/Vi molar ratio | 0.5 | 0.5 | 0.5 | 0.6 | 0.5 | 0.4 | 0.5 | 0.4 |
| Penetration Value | 264.7 | 259.6 | 245.5 | 152.0 | 200.0 | 290.7 | 247.4 | 215.8 |
| Penetration Depth (mm) | 6.42 | 6.28 | 5.91 | 3.41 | 4.70 | 7.11 | 5.96 | 5.12 |
| Tan Delta @ 1 Hz | 0.86 | 0.90 | 0.94 | 0.32 | 0.50 | 1.10 | 0.63 | 0.41 |
| Tan Delta @ 50 Hz | 2.09 | 2.09 | 2.05 | 1.32 | 2.00 | 2.23 | 1.68 | 2.09 |
| Tan Delta @ 70 Hz | 2.46 | 2.24 | 2.06 | 1.49 | 2.32 | 2.28 | 2.24 | 3.02 |

TABLE 3

| Sample | 9 | 10 | 11 | 12 | 13 | 14 | 15 | 16 |
|---|---|---|---|---|---|---|---|---|
| LV1 (wt %) | 0 | 61.39 | 52.29 | 0 | 59.03 | 0 | 0 | 47.15 |
| LV2 (wt %) | 42.16 | 0 | 0 | 27.25 | 0 | 26.10 | 27.16 | 0 |
| LV3 (wt %) | 42.15 | 0 | 0 | 27.25 | 0 | 26.10 | 22.37 | 0 |
| AFPR 1 (wt %) | 0 | 0 | 0 | 39.13 | 36.18 | 37.47 | 25.00 | 50.00 |
| AFPR 2 (wt %) | 0 | 26.30 | 31.38 | 0 | 0 | 0 | 0 | 0 |
| Crosslinker (wt %) | 13.66 | 10.28 | 8.30 | 4.34 | 2.76 | 8.30 | 23.44 | 0.82 |
| Stabilizer (wt %) | 0.03 | 0.03 | 0.03 | 0.03 | 0.03 | 0.03 | 0.03 | 0.03 |
| Initiator | 2.00 | 2.00 | 2.00 | 2.00 | 2.00 | 2.00 | 2.00 | 2.00 |
| SiH/Vi molar ratio | 0.5 | 0.5 | 0.4 | 0.3 | 0.8 | 0.6 | 0.4 | 0.5 |
| Penetration Value | 70.50 | 72.80 | 94.10 | 451.10 | 103.30 | 234.60 | 49.80 | N/A |
| | | | | | | | | too hard |
| Penetration Depth (mm) | 1.24 | 1.28 | 1.87 | 11.39 | 2.12 | 5.57 | 0.69 | N/A |
| | | | | | | | | too hard |
| Tan Delta @ 1 Hz | 0.01 | 0.08 | 0.11 | 1.68 | 0.20 | 0.16 | 0.58 | Not Gel |
| Tan Delta @ 50 Hz | 0.11 | 0.29 | 0.50 | 4.05 | 0.76 | 0.78 | 0.52 | Not Gel |
| Tan Delta @ 70 Hz | 0.141 | 0.3 | 0.61 | Tore | 0.84 | 0.87 | 0.525 | Not Gel |

Sample 1 illustrates a composition of the present invention with just the linear polyorganosiloxane with terminal vinyl functionality, alkenyl-free polyorganosiloxane resin, crosslinker, stabilizer and initiator. The Tan Delta value at 70 Hz is within the desired 1.0-5.0 range.

Samples 2 and 3 illustrate compositions similar to Sample 1 except with different loading of fumed silica included. Tan Delta values at 70 Hz are within the 1.0-5.0 range.

Samples 4-6 illustrate compositions similar to Sample 1 except with a different linear polyorganosiloxane with terminal vinyl functionality and SiH/Vi molar ratios ranging from 0.4 to 0.6. The Tan Delta values at 70 Hz are within the desired 1.0-5.0 range.

Sample 7 illustrates a composition similar to Sample 1 with the addition of PDMS. The Tan Delta values at 70 Hz are within the desired 1.0-5.0 range.

Sample 8 illustrates a composition similar to Sample 1 except using different linear polyorganosiloxanes with terminal vinyl functionality. The Tan Delta value at 70 Hz are within the desired 1.0-5.0 range.

Sample 9 illustrates a composition similar to Sample 8 except without alkenyl-free polyorganosiloxane resin. The Tan Delta value at 70 Hz is below the desired range of 1.0-5.0, illustrating the need for the alkenyl-free polyorganosiloxane resin.

Samples 10 and 11 are similar to Sample 1, except they use a vinyl functional polyorganosiloxane resin instead of an alkenyl-free polyorganosiloxane resin. The Tan Delta value at 70 Hz is below the desired range of 1.0-5.0, illustrating the need for the resin to be alkenyl-free.

Sample 12 is similar to Sample 8 but with a SiH/Vi molar ratio of 0.3. The Tan Delta value at 70 Hz is not measurable because the sample tears during the test—the sample is not durable enough for use at 70 Hz, illustrating the need for the molar ratio of SiH/Vi to be greater than 0.3.

Sample 13 is similar to Sample 1 except with a SiH/Vi molar ratio of 0.8. The Tan Delta value at 70 Hz is below the desired 1.0-5.0, illustrating the need for the molar ratio of SiH/Vi to be less than 0.8.

Samples 14-18 illustrate a need for the alkenyl-free polyorganosiloxane resin to be present at a concentration in a range of 39 to less than 50 wt % of the composition. When less than 39 wt % the Tan Delta value is below 1.0-5.0. When 50% the Tan Delta is no measurable because the sample is not a gel.

1. A composition comprising:
(a) 45-65 weight-percent of a linear polyorganosiloxane with terminal vinyl functionality;
(b) 39 weight-percent to less than 50 weight-percent alkenyl-free polyorganosiloxane resin comprising R₃SiO_{1/2} and SiO_{4/2} siloxane units at an average molar ratio of greater than zero and at the same time 10 or less; where R is independently in each occurrence selected from a group consisting of alkyl groups containing from one to 10 carbon atoms;
(c) 0.5-15 weight-percent mercapto-functional linear polyorganosiloxane crosslinker;
(d) 0.01-0.1 weight-percent radical stabilizer;
(e) 0.01-3 weight-percent thiol-ene photopolymerization initiator;
(f) 0-10 weight-percent fumed silica; and
(g) 0-5 weight-percent polydimethylsiloxane;
wherein weight-percent values are relative to composition weight, the composition has a molar ratio of SiH/vinyl functional groups that is greater than 0.3 and at the same time less than 0.8 and wherein the composition is free of alkenyl functional polyorganosiloxane resin, free of alkoxysilyl containing components, and free of polysiloxane comprising R^{sH}SiO_{3/2} siloxane units, where R^{SH} is a mercapto-group containing hydrocarbyl.

2. The composition of claim 1, wherein the composition is free of cyclic hindered amines.

3. The composition of claim 1, where the mercapto-functional linear polyorganosiloxane crosslinker comprises the following siloxane units: (R₃SiO_{1/2}), (R₂SiO_{2/2}), and (RR′SiO_{2/2}) where R in each occurrence is selected from hydrogen and hydrocarbyls and R′ is an alkyl with a terminal thiol group.

4. The composition of claim 3, wherein each R is a methyl and R′ is —CH₂CH₂CH₂SH.

5. The composition of
claim 1, wherein the composition is free of polysiloxanes having (RSiO_{3/2}) siloxane units where R comprises alkenyl and/or thiol functionality.

6. The composition of
claim 1, wherein the composition is free of alkoxy functional polysiloxanes.

7. A process comprising:
(a) applying the composition of claim 1 to a substrate; and
(b) exposing the composition to light to initiate curing by a thiol-ene reaction.

8. The process of claim 5, wherein the substrate is a component of a lens assembly or other part of a camera assembly.

9. An article comprising an uncured or cured form of the
composition of claim 1 on a substrate.

10. The article of claim 9, wherein the substrate is a component of a lens assembly or camera.
